(19) United States
(12) Patent Application Publication
(10) Pub. No.: US 2025/0265123 A1
(43) Pub. Date: Aug. 21, 2025

(54) Hardware Packet Receiver

(71) Applicant: TEXAS INSTRUMENTS INCORPORATED, Dallas, TX (US)

(72) Inventors: Joseph Aronson, Dallas, TX (US); Denis R. Beaudoin, Rowlett, TX (US)

(21) Appl. No.: 18/902,232

(22) Filed: Sep. 30, 2024

Related U.S. Application Data
(60) Provisional application No. 63/553,690, filed on Feb. 15, 2024.

(51) Int. Cl. G06F 9/50

(52) U.S. Cl. CPC G06F 9/5016; G06F 9/5038

(57) ABSTRACT

A packet receiver in a network accelerator may be based on hardware logic. The packet receiver may be configured so that, once it receives a packet, it may transmit to a memory manager an indication of the packet size and may perform read a pointer to a data allocation for the packet size. Once the packet receiver receives the allocation, it may store the packet into an allocated address range in a data memory.

### CROSS-REFERENCE TO RELATED APPLICATIONS

The present application claims the benefit of U.S. Provisional Patent Application 63/553,690, filed Feb. 15, 2024, the disclosure of which is hereby incorporated by reference in its entirety.

### TECHNICAL FIELD

The present disclosure relates generally to a hardware packet receiver and, more specifically, to a hardware packet receiver implemented in a network accelerator.

### BACKGROUND

When receiving data in a digital system, there may be a significant amount of latency and overhead involved, including data path timing, a receiver's ability to accept data at speed, and metadata plus sideband signals. This gets exacerbated with multiple transmitters communicating with the same receiver via parallel channels or threads. In many such systems, the receiver becomes a bottleneck, since it must handle the most data bandwidth.

There are proposed techniques to mitigate many-to-one receiver bandwidth issues such as scaling up the receiver's data interfaces to handle more data input at a time or improving receive path throughput and efficiency to accept data for a higher percentage of time.

### SUMMARY

In an arrangement, a method includes receiving a packet; providing a request for an allocation of a portion of a memory, wherein the request indicates a size associated with the packet; based on the request, receiving a first pointer associated with the memory; and writing at least a portion of the packet to the memory using the first pointer.

In an arrangement, a network accelerator includes: a packet receiver; a data memory; and hardware logic, wherein the packet receiver is configured to: receive a packet; provide a request for memory allocation for the packet based on a size associated with the packet; and write at least a portion of the packet to the data memory in response to receiving the memory allocation; and wherein the hardware logic is configured to: receive the request for the memory allocation from the packet receiver; determine the memory allocation based on the size associated with the packet; and provide the memory allocation to the packet receiver as a pointer to a location in the data memory.

In an arrangement, a packet receiver includes hardware logic configured to: receive a packet having packet size data; request a data memory allocation from hardware logic based on the packet size data; receive a data memory allocation from the hardware logic; write at least a portion of the packet to the data memory according to the allocation; and transmit a pointer to either a processor core or a packet transmitter, wherein the pointer is configured to cause a function to be performed on the packet.

### BRIEF DESCRIPTION OF THE DRAWINGS

Having thus described the invention in general terms, reference will now be made to the accompanying drawings, wherein:

FIG. 1 is an illustration of an example packet receiver, adapted according to some embodiments.

FIG. 2 is an operational illustration of a method of an example state machine, which represents the operation of the state machine hardware logic of FIG. 1, according to some embodiments.

FIG. 3 is an illustration of an example process, for interaction among state machine hardware logic, priority manager, and memory manager, according to some embodiments.

FIG. 4 is an illustration of an example packet format, for use by a packet receiver to write a packet to a data memory, according to some embodiments.

FIG. 5 is an illustration of an example method, for handling a packet, according to some embodiments.

FIG. 6 is an illustration of an example network accelerator, which may include a packet receiver (e.g., the example packet receiver of FIG. 1), according to some embodiments

FIG. 7 is an illustration of an example system on-chip (SoC), on which an example network accelerator may be implemented, according to some embodiments.

### DETAILED DESCRIPTION

The present disclosure provides a multi-threaded packet receiver that, in some examples, automatically allocates memory space for packets being received on each thread in parallel. The memory space may be used to store the contents of packets until they are processed by a processor core and/or may be used to store packets until they can be forwarded to another receiver. The receiver may be tightly-coupled to the memory in which it writes the packet data, which leads to minimal wait states when writing. It is a configurable and scalable design that can have any number of threads.

When the start of a packet is received, the receiver may request a buffer allocation from memory. Once allocated, the receiver transfers the data from the packet interface to its buffer. In an example, the packet interface allows one data word from one thread at a time, so data across threads get arbitrated. Thus, the receiver is able to track packet states across threads and make efficient use of the memory interface. The receiver's packet and memory interfaces may be sized appropriately to handle the combined throughput from the connected transmitters.

The receiver may contain local storage in the form of a first in first out (FIFO) buffer for each thread that can hold up to two elements. This allows for the reception of two words per thread without any other memory accesses being requested by the receiver; it may also increase the efficiency of the memory interface because the receiver can arbitrate between threads that have data waiting and ready to be transferred to memory rather than waiting on the packet interface itself.

While no particular advantage is required for any particular embodiment, in some examples, the tightly-coupled memory enables fast, efficient transfers with minimal delay. Similarly, automatic allocation of memory at the start of each packet may allow for minimal latency from packet interface to memory. In some examples, the receiver includes one or more FIFO buffers per thread to locally store packet data, which may improve memory interface usage. In some examples, the receiver leverages parallel work across threads when possible, with thread state logic and memory interface bus FIFO buffer to improve performance. In these ways and others, some embodiments are able to maintain high packet throughput with any number of threads while maintaining a small area footprint.

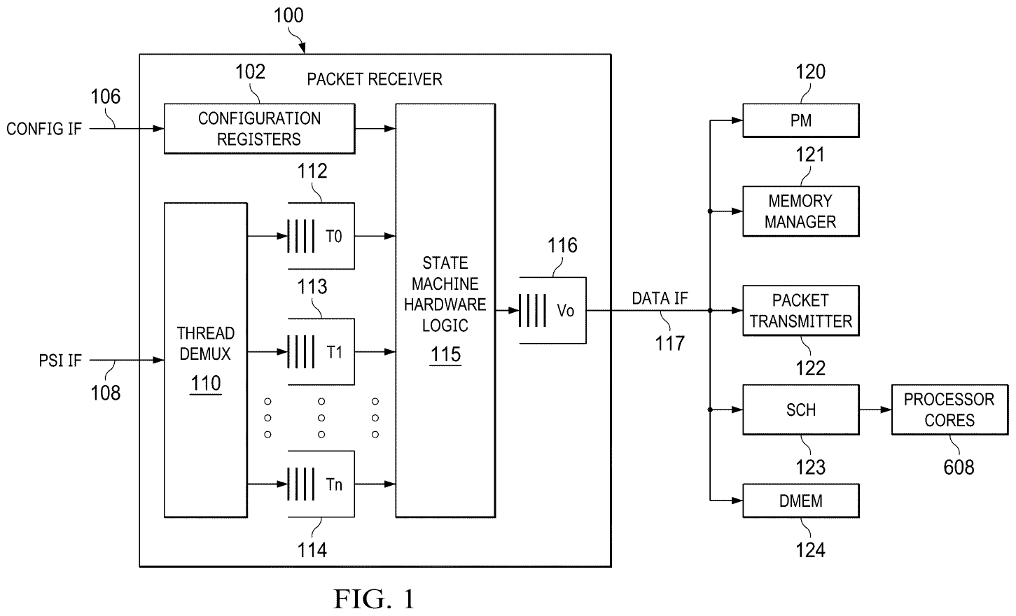

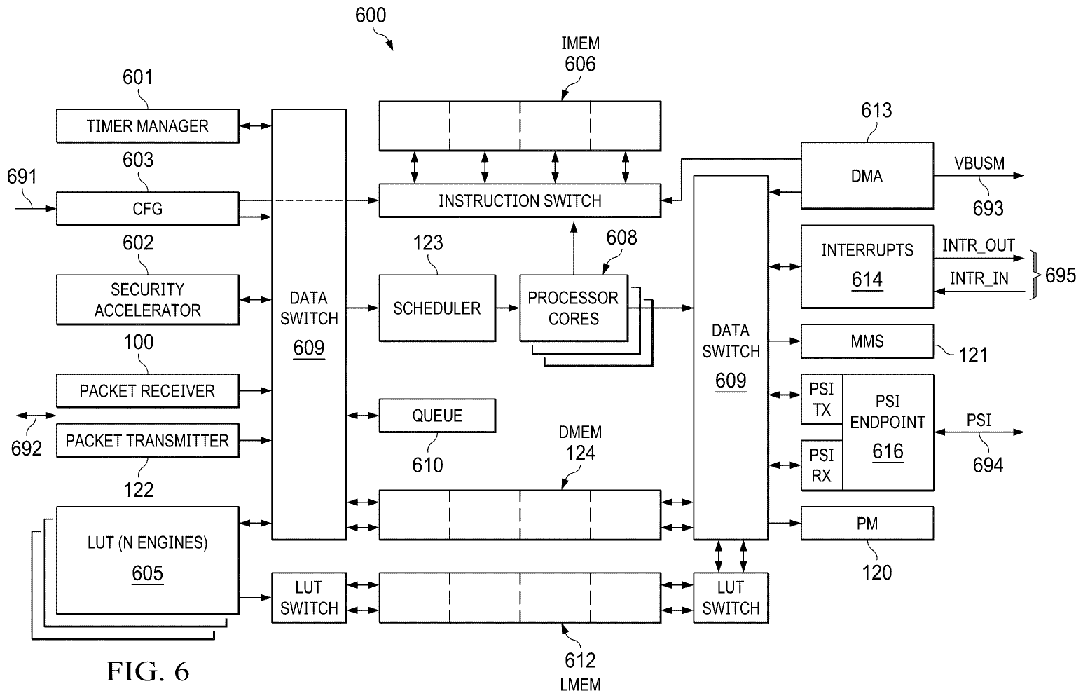

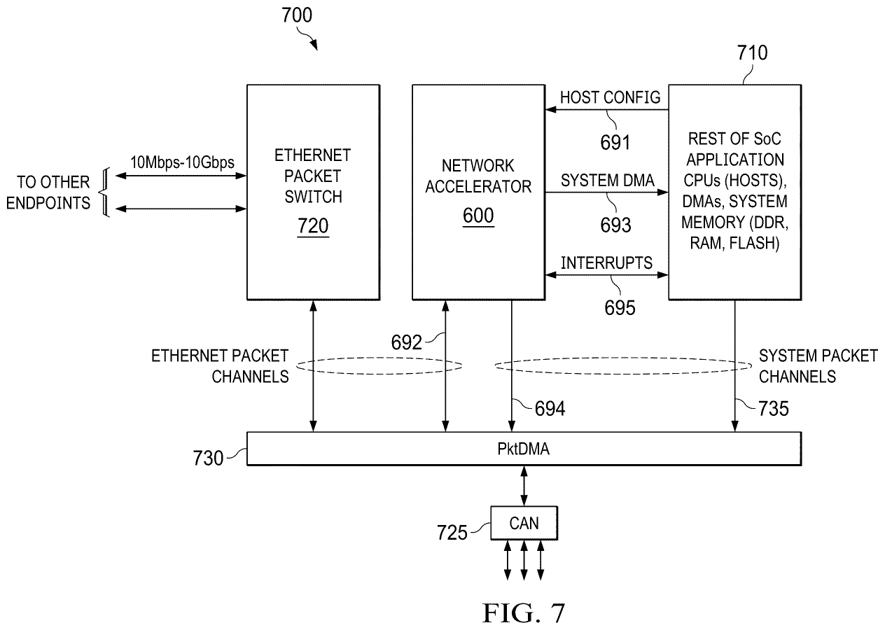

FIG. 1 is an illustration of example packet receiver 100, adapted according to some embodiments. Packet receiver 100 may be implemented in any appropriate manner, such as in a network accelerator, which itself is implemented within a system on-chip (SoC). An example of a network accelerator includes network accelerator 600 of FIG. 6, and an example SoC includes SoC 700 of FIG. 7.

In one example, a packet is received at a network accelerator from an endpoint (e.g., one of packet switches 720, 725 of FIG. 7) within the SoC. Each packet belongs to a thread, where a thread is a logical construct referring to an exchange of packets between two endpoints. For example, a first endpoint (e.g., packet switch 720) and a second endpoint (e.g., packet switch 725) may be associated with a first thread, the first endpoint and a third endpoint may be associated with the second thread, the second endpoint and a fourth endpoint may be associated with the third thread, and on and on. Each of the threads is associated with a thread identification (ID).

The packet is received by the packet receiver 100 on packet interface 108. Thread demultiplexer 110 receives the packet from the packet interface 108, and the thread demultiplexer 110 then assigns the packet to one of the first in first out (FIFO) buffers 112-114 based on the thread ID associated with the packet. In other words, in this example, each of the individual FIFO buffers 112-114 may be associated with a different thread, and the thread demultiplexer 110 may use a thread ID of the incoming packet to transmit the incoming packet to a corresponding one of the FIFO buffers 112-114. FIG. 1 illustrates N FIFO buffers 112-114, and N may be any positive integer of a size appropriate to handle an expected number of threads.

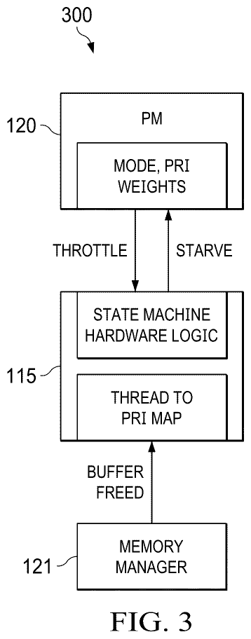

The state machine hardware logic 115 arbitrates from the FIFO buffers 112-114 to receive a packet, perform state machine functions on the packet, and then communicate an output to one of the devices 120-124 via FIFO buffer 116 and data interface 117. The operation of state machine hardware logic 115 is described in more detail with respect to FIG. 3.

In one example use case, a device, such as an application processor core (e.g., in 710 of FIG. 7) on the SoC (e.g., SoC 700 of FIG. 7) may configure how the packets of a thread are treated via the configuration interface 106. For instance, the device may write data to the configuration registers 102, and those configuration registers 102 may be accessed by the state machine hardware logic 115 to determine how to handle a given packet.

Continuing with the example use case, a packet may be received on the packet interface 108, be demultiplexed into a FIFO buffer, e.g., FIFO buffer 112, and the state machine hardware logic 115 may then acquire an allocation for the packet in the data memory 124. For instance, a first-received word of the packet may be formatted so that it includes data regarding a size of the packet. The state machine hardware logic 115 may then parse that first-received word from FIFO buffer 112 and may further request data memory allocation from memory manager 121 based on that packet size. In one example, the packet receiver 100 is configured to process a plurality of different sizes of packets, which may have different packet formats. The memory manager 121 may be configured to allocate memory in the data memory 124 based on a size of the particular received packet.

In this example use case, the state machine hardware logic 115 may transmit packet size data to the memory manager 121, either through FIFO buffer 116, on a sideband signal, or other appropriate manner. The memory manager 121 causes the state machine hardware logic 115 to read from a register that corresponds to the packet size data. For instance, the memory manager 121 may include a multitude of sets of registers, each one of those sets of registers corresponding to a different packet size. Upon receiving the allocation request from the state machine hardware logic 115, the memory manager 121 may cause the state machine hardware logic 115 to read from a register associated with a size corresponding to the packet size data. The reading may return a pointer to a location in the data memory 124 at which the state machine hardware logic 115 may write the packet.

Once the state machine hardware logic 115 writes the packet to the location in the data memory 124, the state machine may cause an event to be either sent to the processor scheduler 123 for execution by one or more processor cores 608 or sent to the packet transmitter 122. In one example, the configuration registers 102 may store an indication of whether a particular thread is associated with an event to the processor scheduler 123 or to the packet transmitter 122. The state machine hardware logic 115 may access the configuration registers 102, read a configuration associated with the thread ID of the packet, and then send an event to the processor scheduler 123 or the packet transmitter 122 as appropriate.

Furthermore, the embodiment of FIG. 1 includes the state machine hardware logic 115 accessing the priority manager 120. For instance, the configuration registers 102 may include priority information, identifying some threads as having a priority level different than that of other threads. The state machine hardware logic 115 may request a grant from the priority manager 120 before requesting an allocation from the memory manager 121. The priority manager 120 may either give the grant or not give the grant based upon the priority level of the thread and based upon unused capacity in the data memory 124. In short, the priority manager 120 may cause higher-priority packets to be written to the data memory 124 before lower-priority packets are written, assuming that there is any conflict for space in the data memory 124. In the absence of priority, the state machine hardware logic 115 may service the FIFO buffers 112-114 in any appropriate manner, such as in a round robin fashion.

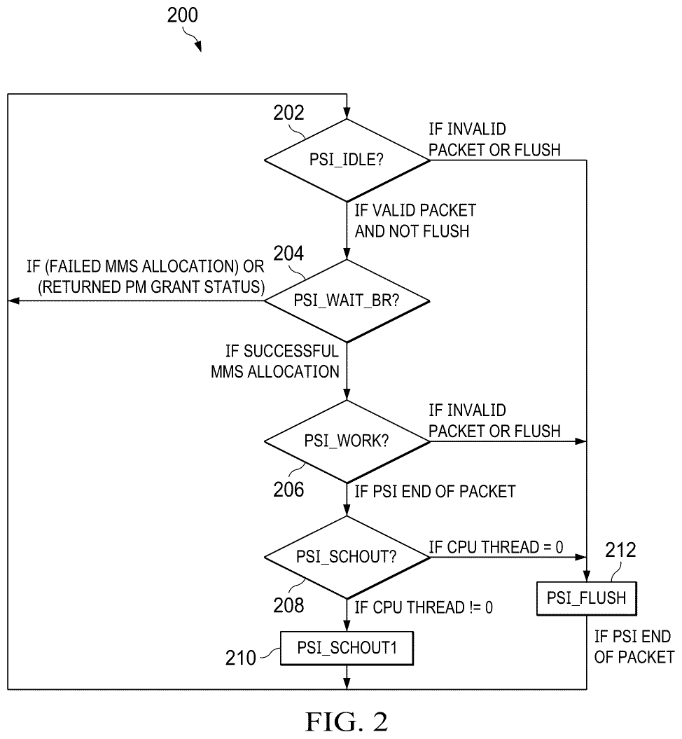

As noted above, the configuration registers 102 may be written, via the configuration interface 106, to allow for settings for the threads. In the example of FIG. 1, the configuration registers 102 may be configured as memory mapped registers (MMRs), which may be mapped to memory space of an application processor core (e.g., in 710 of FIG. 7), which may execute a program to configure the settings. In one example, the configuration registers 102 may include the following registers, per thread:
CPU_RT: Processor core function's real time level (0=NRT, 1=RT). The state machine hardware logic 115 may use the real time status to transmit an event to either a real time (RT) interface of the scheduler 123 or a nonreal time (NRT) interface of the scheduler 123.
CPUTHR: Processor core function or packet transmitter thread's buffer pointer MMR address.
MODE: Event select between packet transmitter or scheduler (0=packet transmitter, 1=scheduler). The state machine hardware logic 115 may use this register to determine whether to transmit an event to the scheduler 123 or the packet transmitter 122.
FLUSH: Determines whether to drop all data on thread or not (0=no flush, 1=flush). A flush operation is described in more detail with respect to FIG. 2.
THROTTLE: When set, causes working threads to be throttled when in starve mode. (Applies to all PSI Threads.) Throttle is discussed in more detail with respect to FIG. 3.
PRI: PSI thread priority level used by priority manager 120. Priority is discussed above and below.
PAD: Number of 8-byte pad blocks allocated after packet. For instance, when a packet is received, if that packet does not align with a certain length, the state machine hardware logic 115 may add padding bytes.
MAXRDY: Max number of packets from this thread that are allowed in the network accelerator before being freed (credits). This is described in more detail with respect to FIG. 3.
PKTOFF: 8-byte offset for packet payload data words. This parameter indicates where the payload of a packet begins.

Of course, the scope of implementations may include any appropriate quantity and type of registers.

FIG. 2 is an operational illustration of a method 200 of an example state machine, which represents the operation of state machine hardware logic 115 of FIG. 1, according to some embodiments. In other words, state machine hardware logic 115 may be implemented using hardware, and during normal operation, state machine hardware logic 115 may perform the actions illustrated in FIG. 2.

Further, in this example, a separate instance of method 200 may be used to perform each thread. Thus, in the example of FIG. 1, in which there are N quantity of threads, the state machine hardware logic 115 may have a respective state machine for each of the N threads. Furthermore, state machine hardware logic 115 may be configured to operate not just on one thread at a time but may interleave some actions of multiple threads during normal operation, thereby providing parallel processing for multiple threads. In such examples, the state machine hardware logic 115 may perform actions corresponding to multiple state machines (e.g., multiple instances of method 200) during a period of time.

State 202 is an idle state, and state 202 corresponds to a time between finishing with one packet of a thread and starting with a next packet of the same thread. In the idle state 202, when a packet is received or selected from the FIFO buffers 112-114 by the state machine hardware logic 115, it checks if the packet is invalid or whether one of the registers 102 for that thread indicates to flush. If so, the state machine moves to state 212, which flushes the packet from its corresponding FIFO buffer (e.g., any of 112-114) and flushes any data with respect to the packet in the data memory 124. Once the packet is flushed, the method 200 returns to the idle state 202.

However, if the corresponding one of the registers 102 does not indicate to flush that thread and if the packet is valid, then the method 200 moves to state 204. At state 204, the state machine hardware logic 115 interacts with the memory manager 121 and the priority manager 120 to get an allocation in the data memory 124 for the packet. The interaction of the state machine hardware logic 115 with the priority manager 120 and the memory manager 121 is described in more detail with respect to FIG. 3.

In an example in which the state machine hardware logic 115 fails to get a grant from the priority manager 120 or an allocation from the memory manager 121, the method 200 may move back to the idle state 202 and return to the state 204 to re-try. Some examples of method 200 may include an appropriate quantity of re-tries to receive a grant and an allocation before moving to the flush state 212.

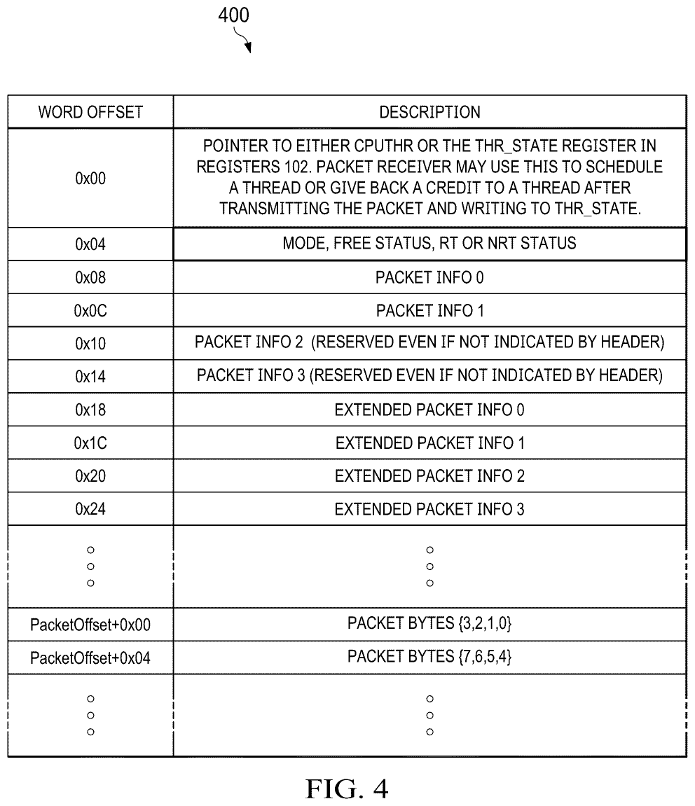

Once a grant is received and an allocation is received by the state machine hardware logic 115, the method 200 moves to state 206, which includes writing the packet to the allocated location in the data memory 124. Once again, if the state machine hardware logic 115 determines that the packet is invalid, or if a corresponding register of configuration registers 102 indicates to flush, then the method 200 may move to the flush state 212. Otherwise, the state machine hardware logic 115 completes writing the packet to the end of the packet in the data memory 124 and then moves to state 208. The state machine hardware logic 115 may write the packet to the data memory according to any appropriate format, an example format being the format illustrated in FIG. 4 (described below).

State 208 includes reading from a CPUTHR register for that thread from registers 102. If the CPUTHR is empty (i.e., stores a value such as 0), then the state machine hardware logic 115 may move to the flush state 212. However, if there is a pointer in the CPUTHR register, then the method 200 may move to state 210, which includes checking the MODE register for that thread in registers 102. The particular MODE may be set to indicate whether a pointer from state 208 should be sent to either the packet transmitter 122 or the processor core scheduler 123. At state 210, the state machine hardware logic 115 sends the pointer to the packet transmitter 122 or the processor core scheduler 123 based on the value in the MODE register. The pointer may point to an address that includes an indication of a processor core function or a function to be performed by the packet transmitter 122. In this example, the pointer at state 210 represents the event, which the state machine hardware logic 115 transmits to the packet transmitter 122 or the processor core scheduler 123.

Once the state machine hardware logic 115 has transmitted the pointer at state 210, method 200 moves back to the idle state 202 to await a subsequent packet for that thread.

As the state machine hardware logic 115 moves through the states, it may write to one or more additional registers for that thread in the configuration registers 102. Such registers may be written by the state machine and may be treated as read-only by an application processor. The information in such registers may be used for diagnostic purposes or for any appropriate purpose. Examples of registers and information, which may be written by the state machine hardware logic 115, may include:
PTR: Currently allocated buffer pointer in data memory 124 that thread is working on.
TPEND: Current thread pending bit.
THRCNT: Number of threads supported by the packet receiver 100.
CURRDY: Current number of outstanding packets on the thread being processed in the network accelerator.
THR_STATE: Current thread state. Writing will return a credit to the thread.

FIG. 3 is an illustration of example process 300, for interaction among state machine hardware logic 115, priority manager 120, and memory manager 121, with respect to state 204 of FIG. 2, according to some embodiments.

The state machine hardware logic 115 may request a grant from the priority manager 120, assuming the state machine hardware logic 115 is not in a round-robin mode. Subsequently, the priority manager 120 may return a grant based at least in part on a priority of a thread to which the particular packet belongs. However, if the priority manager 120 does not return a grant to the state machine hardware logic 115, then the state machine hardware logic 115 may retry after the memory manager 121 indicates that there is new space to be allocated in the data memory 124 (i.e., buffer freed).

Once the grant is returned to the state machine hardware logic 115 from the priority manager 120 (or if the state machine hardware logic 115 is operating in round-robin mode), then the state machine hardware logic 115 may request allocation in the data memory 124 from the memory manager 121. In some instances, allocatable space in the data memory 124 may have been taken in the meantime, so there is a possibility that the memory manager 121 may fail to provide an allocation. In such an instance, assuming that the grant has been received or the state machine hardware logic 115 is in round-robin mode, then the state machine hardware logic 115 may be forced to wait until receiving a “buffer freed” signal from the memory manager 121. Once the state machine hardware logic 115 receives the allocation from the memory manager 121, then the state machine hardware logic 115 may write the packet to the data memory 124 at a location indicated by the allocation.

In some examples, the memory manager 121 may track allocatable space in the data memory 124 by using credits, so that a positive integer number of credits indicates available space, whereas zero credits indicates that there is no allocatable space at that moment. Packet credits may be tracked by the packet receiver 100 on a per-thread basis. The number of credits may be based on unused capacity in the data memory 124, a current number of outstanding packets being processed (CURRDY) (which may reduce a number of credits), and space being freed within the data memory (i.e., buffer freed, which increases a number of credits available).

FIG. 3 also illustrates a starve mode and a throttle mode. The state machine hardware logic 115 enters starve mode when any one of the threads fails to receive an allocation from the memory manager 121 (e.g., by receiving a null pointer from memory manager 121). The state machine hardware logic 115 may exit the starve mode when the memory manager 121 signals that space is available (i.e., buffer freed). When the state machine hardware logic 115 is in starve mode, the priority manager 120 may reject any requests for a grant. Furthermore, when state machine hardware logic 115 is in starve mode, any thread that is waiting for a grant or an allocation may have its grant status reset at state 204, forcing such threads to re-request a grant from the priority manager 120.

The state machine hardware logic 115 enters the throttle mode in response to the THROTTLE register being set and when any thread fails to receive an allocation from the memory manager 121. The state machine hardware logic 115 may exit the throttle mode when the number of working threads (being actively transferred to the data memory 124) decreases to half an amount of working threads at the time the throttle mode was entered. In throttle mode, the state machine hardware logic 115 allows half of the working threads to transfer, while taking no action on the other half of the working threads. When one of the working threads completes, the state machine hardware logic 115 allows one of the throttled threads to be transferred. This may continue thread-by-thread as one thread completes and another starts being transferred, until the exit condition is reached.

In some examples, the interaction of the state machine hardware logic 115 and the memory manager 121, including a read operation to receive an allocation, may be performed by hardware and be completed as quickly as a single clock cycle. Additionally, a write operation from state machine hardware logic 115 to the data memory 124 may also be performed by the hardware and be completed as quickly as a single clock cycle. However, the scope of implementations includes any design appropriate to perform the actions of method 200.

FIG. 4 is an illustration of an example packet format 400, for use by packet receiver 100 to write a packet to the data memory 124, according to some embodiments. The first field beginning at word offset 00 includes a pointer to either CPUTHR or the THR_STATE register in registers 102. Packet receiver 100 may use the pointer to schedule a thread or give back a credit to a thread after transmitting the packet and writing to THR_STATE.

The field beginning at word offset 04 may include the data from the MODE register, data from the CPU_RT register, and any other appropriate data. For instance, the field beginning at word offset 04 may include an indication that the address range used by the packet has been freed or is currently used.

The fields beginning at word offset 08 and ending after word offset 24 may include packet header data. Of note is the Packet Info 0 and 1 fields, which may include the first-received word of the packet that indicates a size of the packet. This is part of the packet header, and it may be stored in the data memory 124 with the packet.

The packet payload begins at PacketOffset+0×00 and ends after an appropriate number of bytes adequate to store the packet payload.

Of course, packet format 400 is an example, and the scope of implementations may use any appropriate packet format for storing a packet to the data memory 124.

Various embodiments may include advantages over other systems. For instance, in the example of FIG. 1, the state machine hardware logic 115 is configured to automatically request allocation in the data memory 124 when a packet comes in. An advantage may include increased efficiency of semiconductor area by use of hardware, as compared with a software or firmware implementation, which would be expected to use more transistors and more semiconductor area.

Furthermore, the packet may be configured so that the size data is the first-received word, allowing the state machine hardware logic 115 to apply Boolean logic to that first-received word and to request allocation from the memory manager 121 based on the packet size. An advantage includes increased speed of operation, as an allocation may be requested and received perhaps in as few as one clock cycle.

Additionally, the scope of implementations may include the ability to handle packets of different types and of different communication protocols. Specifically, the memory manager 121 may be configured to allocate space in the data memory 124 based on size of packet, where packet size may be different from packet type to packet type and from communication protocol to communication protocol. Various embodiments may allow for more efficient use of space within the data memory 124, so that smaller packets may receive smaller allocations and larger packets may receive larger allocations, and the allocations may be received quickly and efficiently.

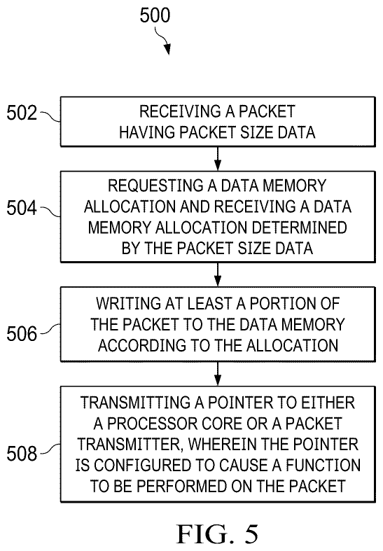

FIG. 5 is an illustration of example method 500, for handling a packet, according to some embodiments. Example method 500 may be performed, e.g., by a packet receiver, such as packet receiver 100 of FIG. 1.

Although not shown in FIG. 5, there may be other actions performed to facilitate method 500. For instance, an endpoint may receive the packet and process the packet before transmitting the packet to the network accelerator (e.g., network accelerator 600 of FIG. 6) that includes the packet receiver 100. Furthermore, a processor core may configure handling of the packet by writing data into configuration registers, such as configuration registers 102. The data in the configuration registers 102 may apply per-thread and may configure the state machine hardware logic 115 to process the packet according to the data in the configuration registers 102.

At action 502, the packet receiver receives a packet having packet size data. In an example, the packet may include the packet size data in a first-received word of the packet. In other words, as the packet is received into the packet receiver and transferred into a FIFO buffer (e.g., any of FIFO buffers 112-114), the first word to enter and traverse the FIFO buffer may include the packet size data.

At action 504, the packet receiver provides a data memory allocation request to hardware logic. In one example, the packet receiver receives the packet, including the packet size data, processes the packet, such as by adding padding, and then requests from the hardware logic to receive an allocation in a data memory. The packet receiver may request a particular size of allocation, where that size may be determined by the packet size data. For instance, the packet size data plus any padding bytes (if applicable) may equal a total packet size, and the packet receiver may place that total packet size onto a signal to be received by a memory manager.

The memory manager may include a multitude of different sets of registers, each of the sets of registers corresponding to a different size for allocation. The hardware logic of the memory manager may direct the data memory allocation request to a particular set of registers in response to the total packet size. As a result, the packet receiver may read from a register, corresponding to the size of the packet, to receive a pointer to a location in the data memory.

An example of performing action 504 is illustrated in FIG. 2 at states 204-206. In other words, in some examples, action 504 may further include receiving a grant based on a priority level of the packet. Furthermore, in some examples, action 504 may also include waiting until the memory manager determines that space is freed and can provide the allocation.

At action 506, the packet receiver may write the data to the packet memory according to the allocation. Specifically, the packet receiver may perform a write operation directed to the location in the data memory, where that location is referred to by the allocation received from the memory manager. In one example, the packet receiver may write at least a portion of the packet according to a format, such as example format 400 of FIG. 4. An example of writing the packet to the data memory may include some action of state 206 of FIG. 2. In one example, if a payload of the packet is only instructions and/or data for the network accelerator's processor cores 608, then action 506 may include storing less than the whole packet structure. For instance, the action 506 may include storing the payload that contains the instructions and/or data in the memory but omitting to store other portions of the packet.

At action 508, the packet receiver may transmit a pointer to either a processor core or a packet transmitter. For instance, depending upon how the thread is configured, the packet receiver may determine to transmit an event (e.g., a pointer to a processor core function) once the packet has been written to the data memory. The event may further include a pointer to the memory location at which the packet is stored in the data memory. Continuing with the example, and depending upon how the thread is configured, the packet receiver may determine to transmit an event (e.g., pushing a pointer to the location the data memory) to a packet transmitter. In any event, the pointer is configured to cause a function to be performed on the packet. In one example, the processor core may perform any appropriate action on the packet, such as modifying the packet, forwarding the packet, dropping the packet, converting the packet to a different format, and/or the like. In another example, the packet transmitter may read the packet from the location in data memory and transmit the packet to another endpoint.

FIG. 6 is an illustration of an example network accelerator 600, which may include a packet receiver (e.g., packet receiver 100 of FIG. 1), according to some embodiments. The example network accelerator 600 may be implemented within a system on-chip (SoC) such as example SoC 700 of FIG. 7.

Network accelerator 600 includes a plurality of processor cores 608, which may include any appropriate processor cores, whether general purpose or otherwise and having any sized instruction set. In one example, each of the processor cores 608 executes firmware to provide processing functionality for network accelerator 600. For instance, the hardware timer manager 601 may perform an action that includes transmitting a function indication and an argument to the scheduler 123 upon expiry of a timer. Scheduler 123 may then pass that function indication and argument to one of the processor cores 508. Furthermore, the processor cores 608 may include functionality to configure registers 102. Processor cores 608 may fetch instructions from instruction memory 606 or receive instruction pointers from direct memory access (DMA) interface 613 via bus 693.

An application processor core (e.g., in 710) may offload network functions to the network accelerator 600 so that the application processor core does not have to perform those functions itself. Configuration interface 603 allows for an application processor core to communicate with any of the components of network accelerator 600. For instance, an application processor core may communicate via bus 691, and such communication may write to registers 102 and/or may cause an instruction to be transmitted to one of the processor cores 608.

Security accelerator 602 may perform security functions on behalf of the processor cores 608. For instance, some types of packets (e.g., ethernet packets) may be designated as un-trusted. In such an example, the processor cores 608 may cause such packets to be indicated as either secure or not secure by security accelerator 602 before further processing.

Packet receiver 100, packet transmitter 122, and packet switch interface (PSI) end point 616 may receive packets and transmit packets into and out of the network accelerator 600 via buses 692 and 694, respectively. Upon receiving a packet, the packet receiver 100 or PSI endpoint 616 may coordinate with memory manager (MMS) 121 to cause space to be allocated within the data memory 124. Once space in the data memory 124 is allocated, the packet receiver 100 or the PSI endpoint 616 may then store that packet to the data memory 124 in the allocated address range.

Network accelerator 600 includes two PSI endpoints-one indicated by packet receiver 100 and packet transmitter 122 and another indicated by endpoint 616—for increased bandwidth, where packet receiver 100 and packet transmitter 122 may be dedicated for ethernet use, and PSI endpoint 616 may dedicated to other packet protocols. However, various embodiments may implement packet receiver 100 and packet transmitter 122 for any appropriate protocol and may implement PSI endpoint 616 for any appropriate protocol. Further, various embodiments may be adapted for either more or fewer PSI endpoints as appropriate.

An application processor core may configure actions to be taken for particular packets in some examples by writing to lookup table entries in lookup table memory 612. When a packet is received and ready for processing, a processor core 608 may cause one of the lookup table engines 606 to perform a lookup table operation within the lookup table entries in lookup table memory 612. A lookup table operation may result in subsequent actions, such as events being sent to scheduler 123 by a lookup table engine 605, where such event may cause an action by a processor core 608.

Queue manager 610 may be used by the processor cores 608 to manage queues in some examples.

The larger system in which network accelerator 600 is implemented (e.g., SoC 700) may transmit interrupts to the processor cores 608 via interrupt interface 614 and buses 695.

Priority manager 120 is implemented to prioritize some packets over other packets, based on configuration data from an application processor core. For instance, some packets may include data indicating a priority level, and the priority manager 120 may perform priority functions, such as enforcing an order of data memory allocation for packets based on priority levels of the packets.

The various components are communicatively coupled within network accelerator 600 by data switches 609.

FIG. 7 is an illustration of an example SoC 700, according to some embodiments. Network accelerator 600 may be implemented on the SoC 700, though the scope of implementations may include network accelerator 600 being implemented in any appropriate system for offload of network functions by any appropriate processor core.

In the present example, ethernet packets may be received by the ethernet packet switch 720. Packets of other protocols, such as control area network (CAN), may be received by packet switch 725. However, the scope of implementations may include more packet switches or fewer packet switches to handle more or fewer communication protocols as appropriate.

Continuing with a packet receive operation, the packets from packet switches 720, 725 are then transmitted to packet direct memory access 730, which in this example, formats the various packets into one or more formats that are efficient for processing by network accelerator 600. Once the packet DMA 730 has formatted the packets, packet DMA 730 may transmit the packets to the network accelerator 600 via buses 692, 694. Packet direct memory access 730 may communicate with the rest of the SoC 710 through system packet channels 735.

As noted above, the network accelerator 600 may perform network functions on the packets, which allows network functions to be offloaded from the rest of the SoC 710. Examples of operations that the network accelerator 600 may perform include, but are not limited to, reformatting a packet from one protocol to another (e.g., ethernet to CAN or vice versa), dropping a packet, forwarding a packet to a different endpoint, sending payload data from a packet to a component of the rest of the SoC 710, and the like. For an outgoing packet, the network accelerator 600 may transmit such packet to the packet DMA 730 via one of buses 692, 694 to either ethernet packet switch 720 or packet switch 725. The network accelerator 600 may also transmit the payload data from the packet to the rest of the SoC 710 via bus 693.

The rest of the SoC 710 may be configured as appropriate. For instance, the rest of the SoC 710 may include one or more processor cores (e.g., application processor cores, digital signal processing cores, and the like) system memory, memory interfaces or accelerators, and the like.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale. In the following discussion and in the claims, the terms “including,” “includes,” “having,” “has,” “with,” or variants thereof are intended to be inclusive in a manner similar to the term “comprising,” and thus should be interpreted to mean “including, but not limited to.” Also, the terms “coupled,” “couple,” and/or or “couples” is/are intended to include indirect or direct electrical or mechanical connection or combinations thereof. For example, if a first device couples to or is electrically coupled with a second device that connection may be through a direct electrical connection, or through an indirect electrical connection via one or more intervening devices and/or connections. Elements that are electrically connected with intervening wires or other conductors are considered to be coupled. Terms such as “top,” “bottom,” “front,” “back,” “over,” “above,” “under,” “below,” and such, may be used in this disclosure. These terms should not be construed as limiting the position or orientation of a structure or element but should be used to provide spatial relationship between structures or elements.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
receiving a packet;
providing a request for an allocation of a portion of a memory, wherein the request indicates a size associated with the packet;
based on the request, receiving a first pointer associated with the memory; and
writing at least a portion of the packet to the memory using the first pointer.

2. The method of claim 1, further comprising:
selecting a device from among a processor core and a packet transmitter for packet; and
after the writing of the at least a portion of the packet to the memory, providing the first pointer to the selected device.

3. The method of claim 2, further comprising:
determining that configuration information for the packet indicates a second pointer for a processor function; and
subsequent to writing the at least a portion of the packet to the memory, transmitting the second pointer to a scheduler associated with the processor core in response to the configuration information.

4. The method of claim 2, further comprising:
determining that configuration information for the packet indicates a second pointer for the packet transmitter; and
subsequent to writing the at least a portion of the packet to the memory, transmitting the second pointer to the packet transmitter in response to the configuration information.

5. The method of claim 1, wherein receiving the packet includes storing the packet in a first in first out (FIFO) buffer, and wherein a first-received word of the packet specifies the size associated with the packet.

6. The method of claim 5, further comprising:
applying padding to the packet prior to the writing of the at least a portion of the packet to the memory, wherein the size associated with the packet accounts for the padding.

7. The method of claim 1, further comprising:
based on the request for an allocation of a portion of a memory, reading the first pointer from a first one of a plurality of registers based at least in part upon the size associated with the packet, wherein each of the plurality of registers is associated with a respective packet size and is configured to store a respective pointer.

8. The method of claim 1, further comprising:
subsequent to receiving the packet and prior to providing the request, requesting a grant from a priority manager; and
receiving the grant from the priority manager.

9. The method of claim 1, wherein the packet is associated with a first thread, and wherein the method further comprises:
processing the first thread and a second thread through respective first in first out (FIFO) buffers.

10. The method of claim 9, wherein processing the first thread and the second thread includes applying a round-robin arbitration using to the respective FIFO buffers.

11. The method of claim 9, wherein processing the first thread and the second thread includes providing the request for the first thread before providing a second request for an allocation for the second thread in response to a priority status associated with the first thread.

12. The method of claim 11, the method further comprising:
determining the priority status of the first thread from a configuration setting.

13. A network accelerator comprising:
a packet receiver;
a data memory; and
hardware logic, wherein the packet receiver is configured to:
receive a packet;
provide a request for memory allocation for the packet based on a size associated with the packet; and
write at least a portion of the packet to the data memory in response to receiving the memory allocation; and
wherein the hardware logic is configured to:
receive the request for the memory allocation from the packet receiver;
determine the memory allocation based on the size associated with the packet; and
provide the memory allocation to the packet receiver as a pointer to a location in the data memory.

14. The network accelerator of claim 13, further comprising a packet transmitter, wherein the packet receiver is further configured to:
transmit an event to the packet transmitter in response to configuration information of the packet.

15. The network accelerator of claim 13, further comprising a processor core, wherein the packet receiver is further configured to:
transmit an event to the processor core in response to configuration information of the packet.

16. The network accelerator of claim 13, wherein the packet receiver is further configured to
request a grant from the hardware logic based on a priority level of the packet, and wherein the hardware logic is further configured to provide the grant to the packet receiver in response to determining that space is available in the data memory.

17. The network accelerator of claim 13, wherein the packet receiver is configured to receive the packet via a first in first out (FIFO) buffer, wherein a first-received word of the packet includes packet size information, further wherein the packet receiver is configured to use the packet size information to request the memory allocation.

18. A packet receiver, wherein the packet receiver includes hardware logic configured to:
receive a packet having packet size data;
request a data memory allocation from hardware logic based on the packet size data;
receive a data memory allocation from the hardware logic;
write at least a portion of the packet to the data memory according to the allocation; and
transmit a pointer to either a processor core or a packet transmitter, wherein the pointer is configured to cause a function to be performed on the packet.

19. The packet receiver of claim 18, wherein the packet is a first packet of a plurality of packets in a thread, wherein the packet receiver is configured to request the data memory allocation as part of a state machine that applies to the thread.

20. The packet receiver of claim 18, wherein the hardware logic is configured to:
operation a grant based on a priority level of the packet; and
request the data memory allocation in response to receiving the grant.
